(19) United States
(12) Patent Application Publication
(10) Pub. No.: US 2002/0098824 A1
(43) Pub. Date: Jul. 25, 2002

(54) Method for transmitting information in a communication system, a communication system and wireless communication device

(76) Inventors: Risto Wichman, Helsinki (FI); Pekka Ranta, Nummela (FI)

Correspondence Address: PERMAN & GREEN, 425 POST ROAD, FAIRFIELD, CT, 06430, US

(21) Appl. No.: 10/015,188

(22) Filed: Nov. 19, 2001

(30) Foreign Application Priority Data
Nov. 23, 2000 (FI) 20002568

(51) Int. Cl. H04Q 7/20

(52) U.S. Cl. 455/403; 455/517

(57) ABSTRACT

The invention relates to a method for transmitting information in a communication system (1), which comprises at least a mobile communication network (6), in which information is transmitted from one or more transmitting devices (7a, 7b, 2) to one or more receiving devices (2, 7a, 7b). In the data transmission, at least one training sequence (sᵢ) is used, and in the receiving device (2, 7a, 7b), signals transmitted by at least two antennas (11a, 11b) are received. In the method, different phases of the same training sequence (sᵢ) are used in the data frames transmitted through different antennas (11a, 11b).

The present invention relates to a method of appended claim 1 for transmitting information in a communication system. The invention further relates to a communication system according to the preamble of the appended claim 11, a network element according to the preamble of the appended claim 21, as well as a wireless communication device according to the preamble of the appended claim 22.

Use of some new and upcoming services, such as browsing the Internet, WAP services and multimedia services, load the downlink (from base station to wireless device) of a mobile communication system significantly more than the uplink (from wireless device to base station). Many of these services are likely to be used when the wireless communication device is substantially stationary or moving slowly. Also, mobile communication systems have a limited temporal diversity (or temporal multipath system), which limits the quantity of information and the number of simultaneous connections that can be transferred via the mobile communication system. One solution for reducing the influences of this drawback is to use with the wireless communication device an antenna group composed of two or several antennas, wherein spatial diversity can be utilized, that is, the directional pattern of the antenna group is arranged to point to the base station. However, this solution is relatively expensive and unpractical to use for example because the wireless communication device can move in the course of use, wherein it can be difficult to direct and keep the antenna directed towards the base station. Another solution to the problem is to implement a so-called transmission diversity at the transmission end for example by using at the base station an antenna group of two or more antennas. Thus, at the base station a signal transmitted to a wireless communication device is directed to two or several antennas.

Regardless of whether one antenna or a group of several antennas is used in the transmission and/or reception, channel estimation is performed in the receiver for example to compensate signal distortions caused by multipath propagation. In order to implement this, many mobile communication systems use so-called training sequences, which are known both at the transmission end and at the reception end. Thus, the receiver performs an adjustment of the channel correction block so that the channel correction block compensates the distortions of the estimated channel as efficiently as possible. When several transmitting antennas are used, in prior art systems a separate training sequence is selected for each transmission branch as well as separate training sequences for signals intended for different wireless communication devices. Further, the aim is to select the training sequences for different transmission branches in a manner that the receiver could, as accurately as possible, estimate the transmission path (transmission channels) used by the same emission with different antennas. Consequently, the training sequences are preferably selected in a manner that they possess as favourable cross-correlation properties as possible. In addition, these training sequences should possess as good auto-correlation properties as possible. In practice this requires that the size of the code family is increased. When using for example four transmission antennas at each base station, a training sequence family is required that has a quadruple quantity of training sequences compared to the present, that is 32 different training sequences in the GSM mobile communication system, in order to attain equally favourable attenuation properties for noise of the same channel as with one antenna. If the training sequences are binary and the basic sequence of each training sequence comprises 16 symbols, as in the GSM mobile communication system, it is not possible to obtain very advantageous auto-correlation and cross-correlation properties for these 32 training sequences.

For example the training sequences used in the present-day GSM mobile communication systems have the property that some training sequence pairs show poor cross-correlation results, wherein good results are not obtained in the channel estimation, particularly in unfavourable conditions. To overcome this drawback, new training sequences could be developed, but this alternative is limited for example by the Welch bound:

$$\frac{{φ}_{c}^{2}}{P} + \frac{P - 1}{P ( M - 1 )} \frac{{φ}_{a}^{2}}{P} \geq 1 \qquad ( 1 )$$

in which

φₐ=maximum auto-correlation,

φ_{c}=maximum cross-correlation,

P=code length, and

M=size of code family.

The Welch bound is valid for binary codes that are composed of numerical values 1 and −1. On the basis of this Welch bound it can be concluded that good auto-correlation properties and good cross-correlation properties are difficult to achieve simultaneously. In addition, the Welch bound indicates that when the size of a code family M increases, also the maximum correlations increase. This is disadvantageous since when coded transmission diversity is used, the receiver needs to estimate N times (=number of transmitting antenna elements) more channel frequencies than when only one antenna is used. Moreover, this increases the estimation noise.

It is an aim of the present invention to provide a method and a system for performing a channel estimation in a receiver. The invention is based on the idea of transmitting a signal to different transmission antennas in a manner that in the signals transmitted in different antenna branches the same training sequence is used so that the phase of the training sequence is different in the different antenna branches. More precisely, the method according to the present invention is primarily characterized in what will be presented in the characterizing part of the appended claim 1. The communication system according to the invention is primarily characterized in what will be presented in the characterizing part of the appended claim 11. The network element according to the invention is primarily characterized in what will be presented in the characterizing part of the appended claim 21. Further, the wireless communication device according to the invention is primarily characterized in what will be presented in the characterizing part of the appended claim 22.

The present invention provides considerable advantages to solutions of prior art. The method of the invention is capable of improving the performance of the channel estimation in a receiver to a significant extent compared to prior art methods. In addition, when the method of the invention is applied, no new training sequences are required, but instead existing training sequences can be used. Because there is no need to increase the number of training sequences, the transmitter and the receiver can be implemented in a simpler manner. Furthermore, as the performance of channel estimation is improved, also the quality of the connection and the reliability of the data transfer can be improved.

Also, a more precise estimation of the channel parameters in the receiver makes it possible to lower the transmission power.

Other advantages achieved by preferred embodiments of the invention that can be mentioned include increasing of the data transmission rate, without adding the transmission power, by transferring via different antennas to the wireless communication device information that is independent from each other. Further, by using a preferable embodiment of the invention, signals transmitted by several different wireless communication devices can be distinguished from each other for example at the base station, wherein for example two wireless communication devices can simultaneously transmit to the same base station. In a corresponding manner, it is possible in a wireless communication device to distinguish signals of two or more simultaneously transmitting base stations.

In the following, the invention will be described in more detail with reference to the appended drawings, in which

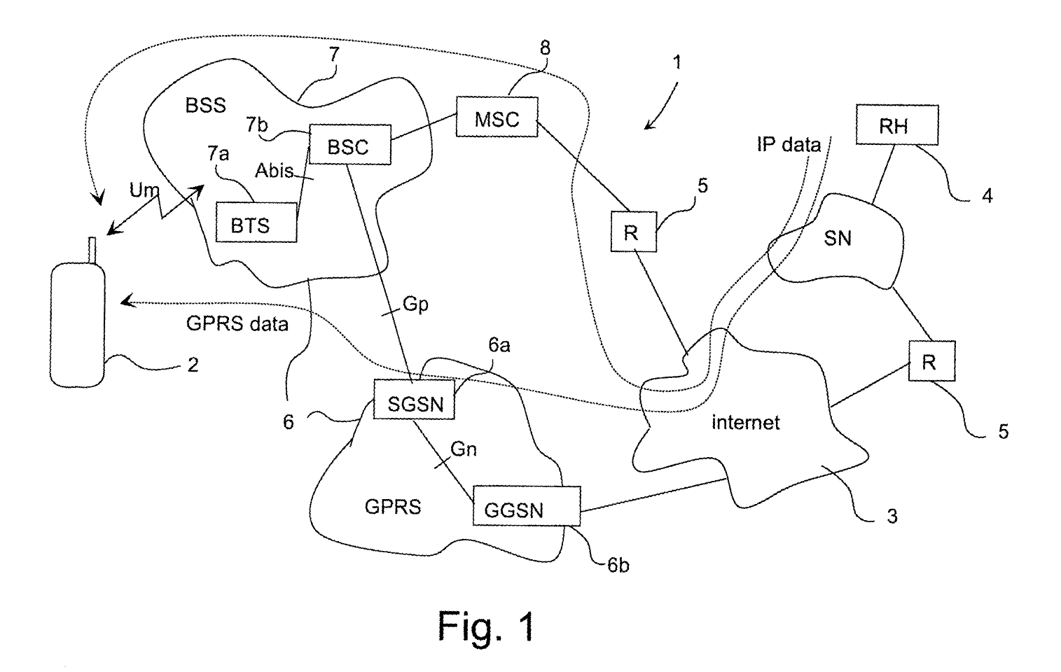

FIG. 1 shows a communication system according to a preferred embodiment of the invention in a reduced block chart,

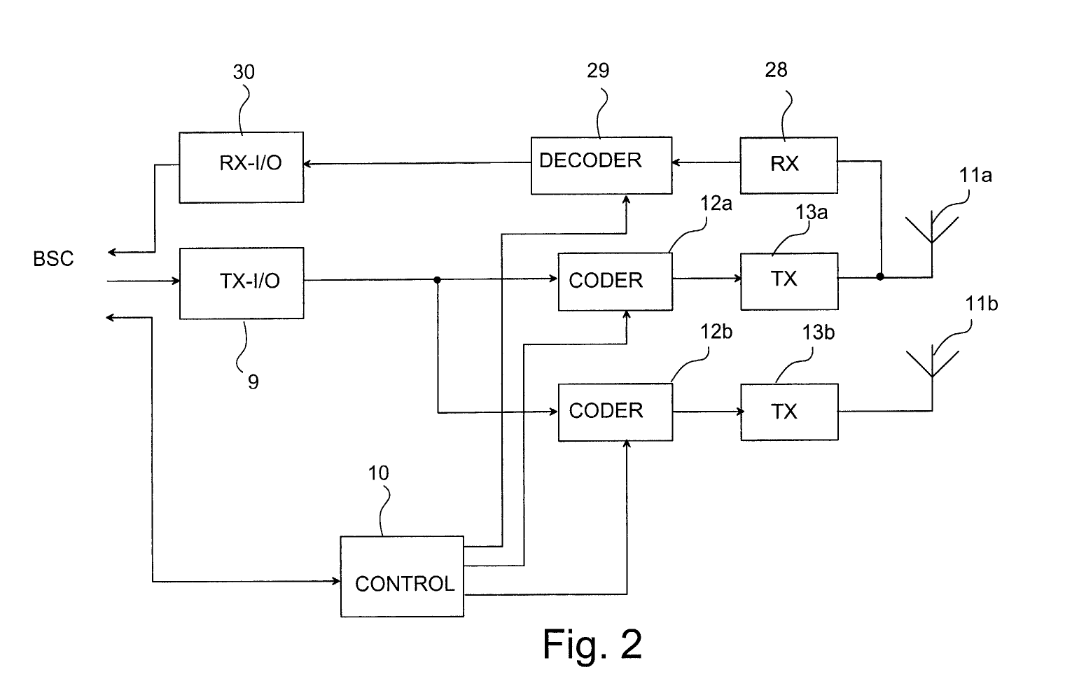

FIG. 2 shows a base station according to a preferred embodiment of the invention in a reduced block chart,

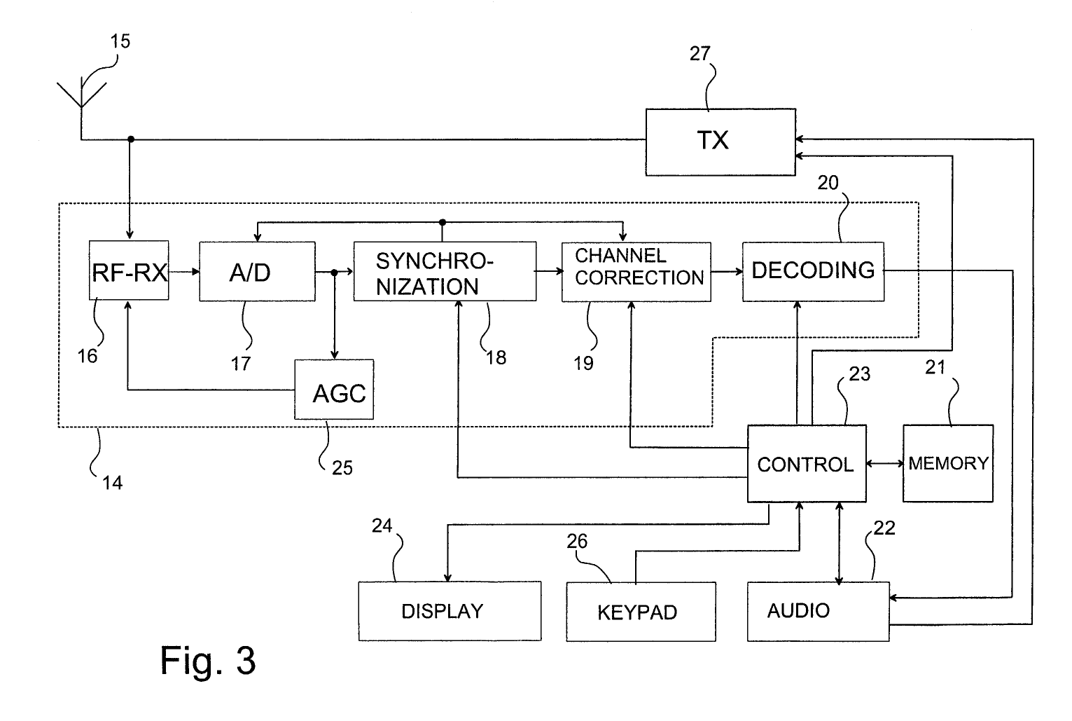

FIG. 3 shows a mobile station according to a preferred embodiment of the invention in a reduced block chart, and

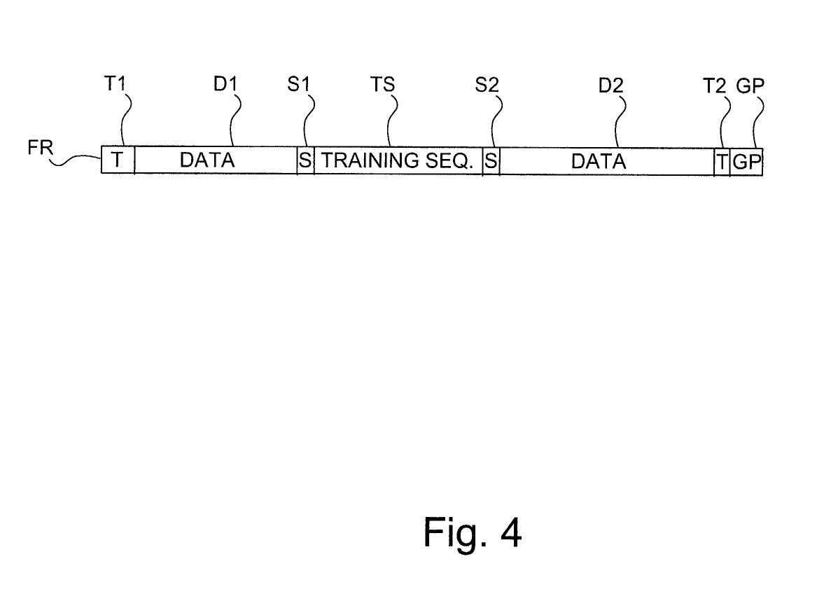

FIG. 4 shows a frame structure that can be applied in the mobile communication system according to a preferred embodiment of the invention.

In the following, the invention will be described in more detail with reference to a communication system 1 according to a preferred embodiment of the invention as shown in FIG. 1. The example uses transmission diversity of two antennas, but it is obvious that the invention can be applied in several transmission antennas as well. Moreover, it is assumed that the communication system comprises a GSM/EDGE system, but it is obvious that the present invention can also be applied also in other mobile communication systems. The user of a wireless communication device 2 can for example browse web pages in the Internet network, wherein the wireless communication device 2 is arranged in a data transmission link with the Internet network 3. The Internet network 3 comprises for example a large number of servers 4 and routers 5 via which information is transferred in a packet format in a way known as such. The data transmission link between the wireless communication device 2 and the mobile communication network 6 is advantageously set up as a packet connection for example using the GPRS (General Packet Radio Service) developed for the GSM mobile communication system.

The functional environment of the GPRS packet switching service comprises at least one subnetwork service area, which is connected to set up a GPRS backbone network. The subnetwork comprises many support nodes (SN), which in this specification are exemplified by serving GPRS support nodes (SGSN) 6a, which are connected to the mobile communication network (typically to a base station by means of a connection unit) in a manner that they can offer packet switching services for wireless communication devices through base stations (cells). The mobile communication network offers packet switching communication between the support node and the wireless communication device. Different subnetworks are, in turn, connected through GPRS gateway support nodes (GGSN) 6b to an external data network, such as the public switched telephone network (PSTN). Thus, the GPRS service enables packet data transmission between a wireless communication device and an external network, wherein certain parts of the mobile communication network set up an access network. In addition, the mobile communication network 6 comprises at least one mobile switching centre (MSC) 8.

Consequently, the wireless communication device 2 communicates with a serving GPRS support node 6a serving through the base station subsystem 7. The base station subsystem advantageously comprises base stations 7a and base station controllers 7b. The actual communication via radio path occurs between the base station 7a and the wireless communication device 2. This description is mainly focused on communication via said radio path, particularly in the downlink direction, that is, from the base station 7a to the wireless communication device 2. FIG. 2 shows a reduced block chart of the configuration of a base station 7a according to an advantageous embodiment of the invention, so that the figure shows mainly those blocks that are most relevant for the understanding the present invention. The information to be transmitted from the mobile communication network 6 to the wireless communication device 2 is advantageously transferred to a transmission buffer 9 or the like. In accordance with the control data transmitted advantageously from a base station controller (BSC) 7b, a control block 10 of the base station takes care for example of timing and framing of packets transmitted to different wireless communication devices 2, as well as selection of training sequences and arranging of phase shift for signals to be transmitted through the different antennas 11a, 11b. Each wireless communication device 2 can be allocated one or more transmitting and receiving time slot. During the transmission time slot, the wireless communication device 2 can send information to the base station 7a. Respectively, during the receiving time slot, the wireless communication device 2 is in the receiving state, wherein information can be transmitted from the base station 7a to the wireless communication device.

The information to be transmitted is transferred from the transmission buffer 9 to coders 12a, 12b, in which information is converted to data frame format (packets) and coded for transmission. The coders 12a, 12b also add a training sequence to the data frames FR. The GSM mobile communication system uses the same training sequence in the data frames transmitted to wireless communication devices 2 operating within the same cell. In traffic performed via the same base station to different wireless communication devices, data frames are transmitted in different time slots, wherein a wireless communication device 2 is in favourable conditions capable of picking data frames addressed to it from data frames addressed to other wireless stations. In the appended FIG. 4, a normal frame of the GSM mobile communication system is presented as an example of a data frame FR. It comprises two padding bit fields T1, T2 used mainly for attenuating the effects of data transmission delays in the reception of data frames (guard time). A training sequence field TS is placed around the midpoint of the data frame. The training sequence field has, on its both sides, stealing flags S1, S2 used for indicating the information type contained in the data frame, wherein a decoder of the receiver can, based on these stealing flags, conclude whether the frame is a signalling frame or a data frame used in transmission of so-called payload information. After the padding bit field T1 the data frame has a first data field D1. A second data field D2 comes after the second stealing flag S2, before the second padding bit field T2. The data fields D1, D2 are used for the transmission of actual information, such as signalling information or payload information. In the end the frame still contains a guard period GP, during which no data is transmitted.

In the system according to a preferred embodiment of the invention, two antennas 11a, 11b are used in the base station. Thus, the training sequence used by the base station 7a is used in the first coder 12a as such, that is, to the data frame in the training sequence field is added said training frequency, which in this context is marked as s₁=[s_{1,12}, . . . , s_{1,16}, s_{1,1}, . . . , s_{1,16}, S_{1,1}, . . . , s_{1,5}]^{T}. The control block 10 defines an optimal phase shift k for coding of the signal transmitted through the second antenna and used in establishing the training sequence field. Said training sequence, whose phase is cyclically transferred k phases, is added to the training sequence field of the packet transmitted through the second antenna in the second coder 12b. This can be indicated as s₂=[s_{1,(12+k)mod 16}, . . . , s_{1,(16+k)mod16}, s_{1,(1+k)mod16}, . . . , s_{1,(16+k)mod16}, s_{1,(1+k)mod16}, . . . , s_{1,(5+k)mod16}]^{T}.

After adding a training sequence, the packet can be modulated in transmission blocks 13a, 13b, after which the modulated high-frequency signal is directed from the first transmission block 13a to the first antenna 11a and, respectively, from the second transmission block 13b the modulated signal is directed to the second antenna 11b. The signals transmitted through antennas 11a, 11b are transmitted substantially simultaneously.

In the receiver 14 of the wireless communication device 2 the signal received through the antenna 15 is converted to an intermediate frequency or baseband in the receiving block 16. Subsequently, conversion of the analog signal to digital format is advantageously performed in an A/D converter 17. On the basis of the signal that has been converted to a digital form, the synchronizing block can synchronize the operation of the received signal. This is advantageously performed according to the data frame of the training sequence field. Because the signal may have been distorted in the transmission path and for example caused by the multipath propagation, the receiver does not necessarily know the exact phase of the signal. Thus, in the synchronising block a correlation is set up between the received signal and the training sequence used in the transmission and known by the wireless communication device 2. In case the received signal and the training sequence used in the correlation correlate, correlation peaks are obtained as a result of the correlation. Based on their temporal location, number and intensity, the synchronizing block may attempt to find out the right timing of signals as well as the channel parameters and set the parameters of the channel correction block 19 to substantially correspond to the properties of the transmission path. In the synchronizing block 18 is stored a certain amount of received information (symbol) converted to a digital form in order to perform correlation. The number of bits that are stored is dependent for example on the length P of the code used in establishing the training sequence and on how many channel pins L are to be defined. If it is assumed that the code length P is 16 and 5 channel pins are needed, P+L=16+5=21 symbols are stored in the synchronizing block. On the basis of this, the synchronizing block 18 communicates the information on the properties of the channel, which it has defined, to the channel correction block 19, which sets its own parameters to correspond to the properties of the channel. Consequently, from the output of the channel correction block 19, a channel corrected signal is obtained, which can be decoded in a decoding block 20 and directed for further processing to other blocks, such as a memory 21, an audio block 22, a control block 23 and/or a display 24 of the wireless communication device 2, which is known as such.

An automatic amplification control block 25 can be used to control the amplification of the receiving block 16 on the basis of the intensity of the received signal. Thus, it is possible to decrease the influence of possible power variations of the received signal in the further processing phase of the signal, such as in channel correction and signal decoding.

The wireless communication device 2 can transmit information to a base station by using the transmission block 27, which is known as such. Reception of signals transmitted by the wireless communication device 2 is performed in the reception block 28 of the base station, in which block the signal is converted to an intermediate frequency or a baseband frequency and treated with an analog-to-digital conversion. Subsequently, the signal is directed to a decoder 29 of the base station for decoding. If needed, the decoded signal can be stored into a reception buffer 30 of the base station prior to transmitting to the base station controller 7b.

Further, the method according to a preferred embodiment of the invention will be described mathematically. When sending from the base transceiver station BTS for example a data frame of FIG. 4 to a mobile station, the information on the training sequence frame of the signal received by the mobile station can be indicated by the following formula:

r[i]=h₁[i]*s₁[i]+h₂[i]*s₂[i]+n[i] (2),

in which

hᵢ illustrates the response of the channel,

sᵢ illustrates the training sequence used in the signal transmitted through the antenna i, and

n illustrates a flat random noise, which is summed with a signal in the data transmission channel and in the transmission and reception devices.

The training sequences used in the present GSM/EDGE systems are 5+16+5 bits long, and eight different training sequences optimized in relation to auto-correlation are used. The training sequences are periodic so that sᵢ=[S_{i, 12}, . . . , s_{i, 16}, s_{i, 1}, . . . , s_{i, 16}, s_{i, 1}, . . . , s_{i,5}]^{T}, that is, the initial part of the contents of the training sequence frame is the same as the end part (5 bits) of the 16-bit training sequence (=P) and, respectively, the end part of the contents of the training sequence frame is the same as the initial part (5 bits) of the training sequence. When P+L of the received training sequence symbols are combined to a vector, this can be illustrated by the formula

r=S₁h₁+S₂h₂+n (3)

in which

$${S}_{i} = [ \begin{matrix}{s}_{i , L} & … & {s}_{i , 1} \\ ⋮ & ⋰ & ⋮ \\ {s}_{i , P + L - 1} & … & {s}_{i , P}\end{matrix} ] \qquad ( 4 )$$

In the formula 4, the symbol L illustrates the number of channel pins to be estimated and s_{i,P+k}=s_{i,k}. By collecting together all symbols that are received, the formula 3 can be presented as follows:

r=[S₁,S₂]└h₁^{T}, h₂^{T}┘^{T}+n=Sh+n (5)

If the channel estimates h₁ and h₂ are defined using the method of the smallest quadratic sum, the result is:

h=(S^{T}S)⁻¹S^{T}r=R⁻¹S^{T}r (6)

On the basis of this operation, the signal paths of the channel can be correlated, but at the same time this increases the reception noise. The magnitude of this disadvantageous side effect can be estimated in the following manner:

δ=10log₁₀(1+tr{R⁻¹}) (7)

In a situation, in which an existing training sequence family is used, the definition of the phase difference between two training sequences can be performed for example in the following manner:

k*=argₖmax10log₁₀(1+tr{R(k)⁻¹}) (8)

in which k^{*} illustrates the optimal phase shift between the training sequences, and R(k)=S(k)^{T}S(k), in which

$$S ( k ) = [ \begin{matrix}{s}_{i , L} & … & {s}_{i , 1} & {s}_{j , k + L} & … & {s}_{j , k + 1} \\ ⋮ & ⋰ & ⋮ & ⋮ & ⋰ & ⋮ \\ {s}_{i , P + L - 1} & … & {s}_{i , P} & {s}_{j , k + P + L - 1} & … & {s}_{j , k + P}\end{matrix} ] \qquad ( 9 )$$

In formula (9), sᵢ and sⱼ, i≠j are part of an existing training sequence family. Generally it can be stated that all channel estimators benefit from small auto-correlation and cross-correlation values, although the wished performance criteria can vary in different receivers.

Advantageous training sequences, which can be used in connection with the invention and which should be mentioned in this context, include orthogonal four planar CAZAC sequences (Constant Amplitude Zero AutoCorrelation) and binary CAZAC sequences. Examples on such sequences can be found for example in A. P. Clark, Z. C. Zhu and J.K. Koshi: “Fast Start Up Channel Estimation”, IEEE Proceedings Vol. 131 Pt. F, No. 4, July 1984, pp. 375 to 381.

In the following, the change in performance caused by transmission diversity in prior art systems is discussed with examples of different training sequences used in the GSM system. By using the formula (7) as a criteria describing the performance of a receiver, the best pair of training sequences used in the GSM system causes a performance deterioration of about 2.5 dB, but with the poorest pair the performance decreases as much as 7 dB, when the training sequences are selected so that five different channel pins can be estimated (L=5). Instead, when applying the method of the invention, it is possible, in the worst possible situation, to reduce performance deterioration to about 4 dB, if the best alternative is searched for the training sequence pairs. Consequently, the optimisation of existing training sequence pairs has now been performed both in relation to auto-correlation and cross-correlation by controlling the relative phase difference between the training sequences. This is crucial in systems applying transmission diversity, wherein signals transmitted to the receiver via different antennas have a substantially equal intensity when received.

In the following, the effect of a transmission diversity on the performance is described in a case where the transmission diversity is implemented using a method of a preferred embodiment of the invention, applying the above-mentioned formulas. In this case, the signal to be transmitted through different antennas comprises the same training sequence sᵢ, but a phase shift is arranged between the training sequences, for example a phase shift (k=2) whose length is for example the length of the L symbols. Thus, the formula (9) can be presented in the form

$$S = [ \begin{matrix}{s}_{i , L} & … & {s}_{i , 1} \\ ⋮ & ⋰ & ⋮ \\ {s}_{i , P + L - 1} & … & {s}_{i , P}\end{matrix} \begin{matrix}{s}_{i , 2 L} & … & {s}_{i , L + 1} \\ ⋮ & ⋰ & ⋮ \\ {s}_{i , P + 2 L - 1} & … & {s}_{i , L + P}\end{matrix} ] \qquad ( 10 )$$

When the formula (7) is now applied again and eight training sequences of the GSM system are used as training sequences, values 2.7 dB in best case and 2.9 dB in worst case are obtained for performance deterioration in a situation where L=5. This also confirms that the auto-correlation properties of the training sequences are better balanced than the cross-correlation properties. When applying a method of the invention it is thus possible to achieve a better final result with a smaller number of training sequences than by using a larger number of training sequences in prior art systems.

According to the defined channel correction parameters, in the channel correction block 19 quantities affecting for example the frequency response of filters are changed if needed, wherein the transfer function of the filter changes. Functions of the synchronizing block 18 and the channel correction block 19 can, to a great extent, be implemented using a digital signal processor (DSP) (not shown).

In systems in which a base station uses the same training sequence for all wireless communication stations 2 having a connection with the base station, the invention can also be implemented as follows. In the receiver 14, the calculation of channel correction parameters is performed during the data frame of such a time slot that is intended to be received by another wireless communication device having a connection with the same base station. Subsequently, parameters of the channel corrector 19 are modified, if necessary, and these modified parameters are used during the reception of the next data frame intended for said wireless communication device 2.

The training sequences used in the GSM mobile communication system have good auto-correlation properties at a length of about 6 or 7 symbols. A cyclic phase shift performed with the method of the invention does not have an effect on the auto-correlation properties of the training sequence. The cross correlation of the training sequence can change depending for example on the auto-correlation function of the original training sequence and on the extent of the phase shift.

The optimal phase shift is advantageously calculated at a base station 7a, preferably in connection with a change of the training sequence used by the base station. When necessary, calculation results can be stored in a memory, wherein in a situation where a selected training sequence has been used earlier, the value of the optimal phase shift can be retrieved from the memory.

When adapting the method of the invention, it is possible to reduce transmit power because the channel parameters can be estimated more accurately than in prior art methods in which the transmission is performed via one antenna.

In a method according to a second advantageous embodiment of the invention, signals that are independent from each other are transmitted from the base station 7a through different antenna branches to a wireless communication device 2. However, in these different antenna branches, the same training sequence is used, but at difference phases. This enables that different signals can be differentiated from each other and therefore different information can be received at the same time in the receiver of the wireless communication device. However, this different information can be information that belongs to the same data group transmitted for example in a manner that odd bits are transmitted through one antenna branch and even bits are transmitted through another antenna branch. This is thus a special embodiment of transmission diversity, a sort of a partially parallel data transmission method. For example the present invention can be applied in so-called BLAST type (Bell Laboratories Layered Space-Time) multiantenna systems to increase the data transfer speed.

In yet another advantageous embodiment of the invention, more than one wireless communication device can simultaneously transmit at the same frequency. In this case, different wireless communication devices apply the same training sequence at different phases. Thus, these signals transmitted by different wireless communication devices are received at the base station. The base station can, on the basis of different phasing of the same training sequence, perform joint channel estimation and distinguish the signals transmitted by the different wireless communication devices from each other. At a device (at base station) receiving in such an embodiment, a signal coming from one antenna is processed as a payload signal transmitted by a certain wireless communication device, and signals coming via other antennas are signals disturbing the signal of said wireless communication device. Respectively, a signal received through another antenna is treated as a signal of another wireless communication device, and signals coming via other antennas are disturbing signals in relation to this signal. Different phasing of the same training sequence can, in accordance with the present invention, reduce the effect of these disturbing signals on the signal received through each antenna.

In a corresponding manner, it is possible in a wireless communication device to distinguish signals of two or more simultaneously transmitting base stations. The signals transmitted by the base stations use the same training sequence with different phases. If base stations transmit different payload signals, the signal transmitted by one base station is a payload signal for the wireless communication device, and signals transmitted by other base stations are noise. In such a situation, the method of the invention can improve noise attenuation of the same channel in a wireless communication device. In a method of an advantageous embodiment of the invention, two or more base stations transmit a payload signal intended for the same wireless communication device. In view of the wireless device, this situation corresponds to a situation described previously in this description where two or more antennas are used at the same base station for transmitting a signal to the wireless communication device. Thus, the antennas of a multi-antenna system can either be at the same base station or at different base stations.

It is obvious that the present invention is not limited solely to the above-presented embodiments, but it can be modified within the scope of the appended claims.

1. A method for transmitting information in a communication system comprising at least a mobile communication network in which information is transferred from one or more transmitting devices to one or more receiving devices at least one training sequence is used in the information transfer, and signals transmitted through at least two antennas are received in the receiving device, wherein a different phase of the same training sequence is used in data frames transmitted through different antennas.

2. The method according to claim 1, wherein the transferred information is divided to be transmitted through at least two antennas to the receiving device, and in the receiving device, an examination is performed for the transmitted information using signals transmitted through different antennas.

3. The method according to claim 2, wherein the transmitting device used is a network element, and the receiving device is a wireless communication device.

4. The method according to claim 1, wherein different signals are transmitted through different antennas, and differentiation of signals transmitted through different antennas is performed in the receiving device.

5. The method according to claim 2, wherein the receiving device used is a network element, in which signals transmitted by at least two wireless communication devices are received, and different phases of the same training sequence are used in at least two of said wireless communication devices.

6. The method according to claim 1, wherein information is transmitted in data frames, which are supplemented with said training sequence.

7. The method according to claim 1, wherein the phase shift of the training sequence used in signals to be transmitted through different antennas is defined by minimizing the interference between the training sequences.

8. The method according to claim 7, wherein the phase shift of the training sequence used in signals transmitted through different antennas is defined by the formula
k^{*}=arg ₖmax10log₁₀(1+tr{R(k)⁻¹})
in which R(k)=S(k)^{T}S(k), in which
$$S ( k ) = [ \begin{matrix}{s}_{i , L} & … & {s}_{i , 1} & {s}_{i , k + L} & … & {s}_{i , k + 1} \\ ⋮ & ⋰ & ⋮ & ⋮ & ⋰ & ⋮ \\ {s}_{i , P + L - 1} & … & {s}_{i , P} & {s}_{i , k + P + L - 1} & … & {s}_{i , k + P}\end{matrix} ] .$$

9. The method according to claim 1, wherein one transmitting device is in connection with two or more receiving devices, and in signals to be transmitted from said transmitting device to said receiving device, different phases of the same training sequence is used.

10. The method according to claim 9, wherein a training sequence family is selected, and wherein for one network element one of said training sequences is selected at a time.

11. A communication system comprising at least one transmitting device, at least one receiving device, means for transmitting information from the transmitting device to at least one receiving device, in which transmission at least one training sequence is used, and the receiving device comprises means for the reception of the signal transmitted through said at least two antennas, and in data frames to be transmitted through different antennas, a different phase of the same training sequence is used.

12. The communication system according to claim 11, wherein the information to be transferred is divided to be transmitted through at least two antennas to the receiving device, and the receiving device comprises means for examining the transmitted information using signals transmitted through different antennas.

13. The communication system according to claim 12, wherein the transmitting device is a network element, and the receiving device is a wireless communication device.

14. The communication system according to claim 11, wherein through different antennas different signals are transmitted, and wherein the receiving device comprises means for differentiation of signals transmitted through different antennas.

15. The communication system according to claim 12, wherein the receiving device is a network element, having means for receiving signals transmitted by at least two wireless communication devices, and different phases of the same training sequence are used in said at least two wireless communication devices.

16. The communication system according to claim 11, wherein it comprises means for transmission of information in data frames, which are supplemented with said training sequence.

17. The communication system according to claim 11, wherein the phase shift of the training sequence used in signals transmitted through different antennas is defined by minimizing the interference between the training sequences.

18. The communication system according to claim 17, wherein the phase shift of the training sequence used in signals transmitted through different antennas is defined by the formula
k^{*}=argₖmax10log₁₀(1+tr{R(k)⁻¹})
in which R(k)=S(k)^{T}S(k), in which
$$S ( k ) = [ \begin{matrix}{s}_{i , L} & … & {s}_{i , 1} & {s}_{i , k + L} & … & {s}_{i , k + 1} \\ ⋮ & ⋰ & ⋮ & ⋮ & ⋰ & ⋮ \\ {s}_{i , P + L - 1} & … & {s}_{i , P} & {s}_{i , k + P + L - 1} & … & {s}_{i , k + P}\end{matrix} ] .$$

19. The communication system according to claim 11, wherein it comprises means for performing an information transfer from at least one transmitting device to two or more receiving devices, and wherein in the signals transmitted from said transmitting device to said receiving device, different phases of the same training sequence are used.

20. The communication system according to claim 19, wherein a training sequence is selected, and the communication system comprises means for selecting at a time one of said training sequences to one network element.

21. A network element to be used in a communication system, comprising means for transmitting information from the network element to a wireless device, in which the transmission uses at least one training sequence, and from which network element information is transmitted with at least two antennas, wherein in data frames transmitted through different antennas, different phases of the same training sequence are used.

22. A wireless communication device be used in a communication system, comprising at least one network element, means for transmitting information from the network element to a wireless communication device, in which the transmission uses at least one training sequence, and information is transmitted by using at least two antennas, wherein the wireless communication device comprises means for reception of the signal transmitted through said at least two antennas, and in data frames transmitted through different antennas, different phases of the same training sequence are used, wherein the wireless communication device comprises means for performing channel correction on the basis of the signal transmitted by at least two different antennas and received by the wireless communication device.
